(19) United States
(12) Patent Application Publication
(10) Pub. No.: US 2025/0391353 A1
(43) Pub. Date: Dec. 25, 2025

(54) DISPLAY MODULE, DISPLAY DEVICE, AND CONTROL METHOD FOR DISPLAY MODULE

(71) Applicants: Chengdu BOE Optoelectronics Technology Co., Ltd., Chengdu, Sichuan (CN); BOE Technology Group Co., Ltd., Beijing (CN)

(72) Inventors: Zheng BAO, Beijing (CN); Lian XIANG, Beijing (CN); Mingqiang WANG, Beijing (CN); Jiuyuan BAI, Beijing (CN); Yuan FANG, Beijing (CN); Gong CHEN, Beijing (CN); Xueying HE, Beijing (CN); Haotian YANG, Beijing (CN); Chang WANG, Beijing (CN); Jiaxiang ZHANG, Beijing (CN); Peng YANG, Beijing (CN); Yi ZHANG, Beijing (CN)

(21) Appl. No.: 18/881,271

(22) PCT Filed: May 24, 2024
(86) PCT No.: PCT/CN2024/095280

§ 371 Date: Jan. 4, 2025

(30) Foreign Application Priority Data
May 25, 2023 (CN) 202310601149.4

(51) Int. Cl. G09G 3/3233

(52) U.S. Cl. CPC G09G 3/3233; G09G 2310/08; G09G 2320/02; G09G 2330/021

(57) ABSTRACT

A display module, a display device, and a control method for the display module. The display module comprises a driving module (1) and a display panel (2). The driving module (1) comprises a data signal output unit (11). The display panel (2) comprises N rows of sub-pixels. A scanning stage of each row of sub-pixels comprises a data writing period and a reserved period immediately following the data writing period; and the data signal output unit (11) is configured to be in an off state in the data writing period of the n-th row of sub-pixels (610), and switch from the off state to an on state in the reserved period of the n-th row of sub-pixels, so as to provide a stable first data signal for the (n+1)-th row of sub-pixels in the data writing period of the (n+1)-th row of sub-pixels, wherein 0<n<N (620).

### CROSS-REFERENCE TO RELATED APPLICATIONS

The present application is a U.S. National Phase Entry of International Application No. PCT/CN2024/095280 having an international filing date of May 24, 2024, which claims the priority to Chinese Patent Application No. 202310601149.4, filed on May 25, 2023 and entitled “Display Module, Display Device, and Control Method for Display Module”, the above-identified applications are incorporated into the present application by reference in their entireties.

### TECHNICAL FIELD

The present application relates to, but is not limited to, the technical field of display panels, and particularly relates to a display module, a display device, and a control method for the display module.

### BACKGROUND

In order to save power consumption, when a display module displays a black line, a data signal output unit in a DIC (Driver IC, a driver chip) is not working, and when the display module displays a white line, the data signal output unit in the DIC works normally. When the scanning of a row of sub-pixels corresponding to black color is finished and the scanning of a row of sub-pixels corresponding to white color is started, the data signal output unit is switched from OFF to ON, and the limitation of the voltage output capability of the data signal output unit is easily to cause the data signal voltage output by the data signal output unit to be abnormal. However, if the data signal with the abnormal voltage is written to the sub-pixels, it will easily lead to an abnormal display and affect the display effect.

### SUMMARY

The following is a summary of subject matters described herein in detail. This summary is not intended to limit the protection scope of claims.

According to a first aspect, an embodiment of the present application provides a display module including a driver module and a display panel, wherein the driver module includes a data signal output unit and the display panel includes N rows of sub-pixels, and a scanning stage of each row of sub-pixels includes a data writing period and a reserved period immediately after the data writing period.

The data signal output unit is configured to be in an OFF state during the data writing period of an nth row of sub-pixels, and to be switched from the OFF state to an ON state during the reserved period of the nth row of sub-pixels, so as to provide a stable first data signal to an n+1th row of sub-pixels during the data writing period of the n+1th row of sub-pixels, 0<n<N.

In the display module provided according to an embodiment of the present application, by controlling the data signal output unit to be in the OFF state during the data writing period of the nth row of sub-pixels, and controlling the data signal output unit to be switched from the OFF state to the ON state within the reserved period of the nth row of sub-pixels, the working time of the data signal output unit is advanced and sufficient time is reserved for the data signal output unit to output the stable first data signal, thereby ensuring that the stable first data signal is written for the n+1th row of sub-pixels during the whole data writing period, avoiding display abnormality and improving the display effect.

According to an embodiment of the present application, the reserved period includes a light-emitting period immediately after the data writing period and an idle period immediately after the light-emitting period.

The data signal output unit is further configured to be in the OFF state during the light-emitting period of the nth row of sub-pixels, and to be switched from the OFF state to the ON state during the idle period of the nth row of sub-pixels, so as to provide the stable first data signal to the n+1th row of sub-pixels during the data writing period of the n+1th row of sub-pixels.

According to an embodiment of the present application, the scanning stage further includes a preparation period immediately before the data writing period.

The data signal output unit is further configured to be switched from the OFF state to the ON state during the reserved period of the nth row of sub-pixels, to output the stable first data signal during the preparation period of the n+1th row of sub-pixels and to provide the stable first data signal to the n+1th row of sub-pixels during the data writing period of the n+1th row of sub-pixels.

According to an embodiment of the present application, the driver module further includes an enabling signal unit.

The enabling signal unit is configured to provide a first potential enabling signal to the data signal output unit during the data writing period of the nth row of sub-pixels; and provide a second potential enabling signal to the data signal output unit during the reserved period of the nth row of sub-pixels.

The data signal output unit is further configured to be in the OFF state during the data writing period of the nth row of sub-pixels based on control of the first potential enabling signal; to be switched from the OFF state to the ON state during the reserved period of the nth row of sub-pixels based on control of the second potential enabling signal, to provide the stable first data signal to the n+1th row of sub-pixels during the data writing period of the n+1th row of sub-pixels.

According to an embodiment of the present application, a moment at which the data signal output unit is switched from the OFF state to the ON state during the reserved period of the nth row of sub-pixels is located between a last one-fifth period and a last one-tenth period of the reserved period.

According to an embodiment of the present application, the first data signal is a data signal corresponding to the maximum display brightness of the display panel.

According to an embodiment of the present application, the display module further includes a voltage module.

The voltage module is configured to provide a second data signal to the nth row of sub-pixels during the data writing period of the nth row of sub-pixels.

According to an embodiment of the present application, the second data signal is a data signal corresponding to the minimum display brightness of the display panel.

According to an embodiment of the present application, the display module further includes a selection module.

The selection module is configured to be in then OFF state during the reserved period of the nth row of sub-pixels and in the ON state during the data writing period of the nth row of sub-pixels, so that the data signal output unit provides the stable first data signal to the n+1th row of sub-pixels.

According to an embodiment of the present application, the driver module further includes a selection signal output unit.

The selection signal output unit is configured to provide a first potential selection signal to the selection module during the reserved period of the nth row of sub-pixels; and provide a second potential selection signal to the selection module during the data writing period of the n+1th row of sub-pixels.

The selection module is further configured to be in the OFF state during the reserved period of the nth row of sub-pixels based on control of the first potential selection signal; and in the ON state during the data writing period of the nth row of sub-pixels based on control of the second potential selection signal, so that the data signal output unit provides the stable first data signal to the n+1th row of sub-pixels.

In a second aspect, an embodiment of the present application provides a display device including the above-described display module.

In the display device provided according to an embodiment of the present application, by controlling the data signal output unit to be in the OFF state during the data writing period of the nth row of sub-pixels, and controlling the data signal output unit to be switched from the OFF state to the ON state within the reserved period of the nth row of sub-pixels, the working time of the data signal output unit is advanced and sufficient time is reserved for the data signal output unit to output the stable first data signal, thereby ensuring that the stable first data signal is written for the n+1th row of sub-pixels during the whole data writing period, avoiding display abnormality and improving the display effect.

According to a third aspect, an embodiment of the present application provides a control method for a display module including a driver module and a display panel, wherein the driver module includes a data signal output unit and the display panel includes N rows of sub-pixels, and a scanning stage of each row of sub-pixels includes a data writing period and a reserved period immediately after the data writing period.

The method includes:

controlling the data signal output unit to be in an OFF state during the data writing period of an nth row of sub-pixels; and

controlling the data signal output unit to be switched from the OFF state to an ON state during the reserved period of the nth row of sub-pixels, to provide a stable first data signal to an n+1th row of sub-pixels during the data writing period of the n+1th row of sub-pixels, 0<n<N.

In the control method for the display module provided according to an embodiment of the present application, by controlling the data signal output unit to be in the OFF state during the data writing period of the nth row of sub-pixels, and controlling the data signal output unit to be switched from the OFF state to the ON state within the reserved period of the nth row of sub-pixels, the working time of the data signal output unit is advanced and sufficient time is reserved for the data signal output unit to output the stable first data signal, thereby ensuring that the stable first data signal is written for the n+1th row of sub-pixels in the whole data writing period, avoiding display abnormality and improving the display effect.

According to an embodiment of the present application, the reserved period includes a light-emitting period immediately after the data writing period and an idle period immediately after the light-emitting period.

Controlling the data signal output unit to be switched from the OFF state to the ON state during the a reserved period of the nth row of sub-pixels, includes:

controlling the data signal output unit to be in the OFF state during the light-emitting period of the nth row of sub-pixels; and

controlling the data signal output unit to be switched from the OFF state to the ON state during the idle period of the nth row of sub-pixels.

According to an embodiment of the present application, a moment at which the data signal output unit is switched from the OFF state to the ON state during the reserved period of the nth row of sub-pixels is located between a last one-fifth period and a last one-tenth period of the reserved period.

According to an embodiment of the present application, the first data signal is a data signal corresponding to the maximum display brightness of the display panel.

Other aspects may become clear after the drawings and the detailed description are read and understood.

### BRIEF DESCRIPTION OF DRAWINGS

Accompanying drawings are used to provide understanding of technical solutions of the present disclosure, and form a part of the specification. The accompanying drawings and embodiments of the present disclosure are adopted to explain the technical solutions of the present disclosure, but do not form limitations on the technical solutions of the present disclosure.

FIG. 1 is a first schematic diagram of a structure of a display module according to an embodiment of the present application.

FIG. 2 is a second schematic diagram of a structure of a display module according to an embodiment of the present application.

FIG. 3 is a third schematic diagram of a structure of a display module according to an embodiment of the present application.

FIG. 4 is a signal timing diagram of a display module in the related art.

FIG. 5 is a signal timing diagram of a display module according to an embodiment of the present application.

FIG. 6 is a schematic flowchart of a control method for the display module according to an embodiment of the present application.

### DETAILED DESCRIPTION

Embodiments of the present application will be described in detail below, examples of the embodiments are shown in the accompanying drawings, where the same or similar reference numerals refer to the same or similar elements or elements with the same or similar functions throughout. Embodiments described herein with reference to the accompanying drawings are exemplary, used for explaining the present application only, but should not be construed to limit the present application.

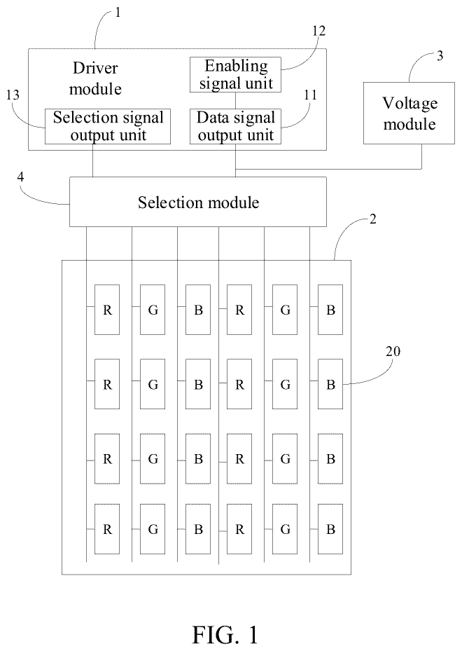

Herein, a display module, a display device, and a control method for the display module provided according to an embodiment of the present application will be described with reference to FIG. 1 to FIG. 6.

FIG. 1 is a schematic diagram of a structure of a display module provided according to an embodiment of the present application.

As shown in FIG. 1, the display module provided according to an embodiment of the present application includes a driver module 1 and a display panel 2. The display panel 2 may be an AMOLED (Active-Matrix Organic Light Emitting Diode) display panel. The display panel 2 includes a plurality of sub-pixels 20, and the plurality of sub-pixels 20 may be arranged in N rows and M columns, N>1 and M>0. The plurality of sub-pixels 20 may include a plurality of color sub-pixels such as a red sub-pixel R, a blue sub-pixel B, and a green sub-pixel G. In a row of sub-pixels, a plurality of color sub-pixels may be arranged alternately, for example, arranged alternately in an order of a red sub-pixel R, a green sub-pixel G, and a blue sub-pixel B. Each sub-pixel 20 includes a pixel circuit including a light emitting device.

When the display panel 2 displays a screen, N rows of sub-pixels are scanned row by row. The scanning stage of each row of sub-pixels includes a data writing period and a reserved period immediately after the data writing period. The data writing period of a row of sub-pixels is a period of time for writing a data signal to the pixel circuits in the row of sub-pixels. The reserved period of a row of sub-pixels is a period of time reserved for the pixel circuits in the row of sub-pixels to drive the light emitting device to emit light or the like based on the written data signal.

The driver module 1 may be a driver chip DIC, and the driver module 1 may be bonded to the display panel 2 by COP (Chip On Panel) technique to reduce the frame of the display module.

As shown in FIG. 1, the driver module 1 includes a data signal output unit 11 configured to be in an OFF state during the data writing period of the nth row of sub-pixels, and to be switched from the OFF state to an ON state within the reserved period of the nth row of sub-pixels, so as to supply a stable first data signal to the n+1th row of sub-pixels during the data writing period of the n+1th row of sub-pixels, 0<n<N.

During the data writing period of the nth row of sub-pixels, the data signal output unit 11 is in the OFF state, that is, the data signal output unit 11 is not working, that is, the data signal output unit 11 does not supply a data signal to the nth row of sub-pixels to save power consumption. Herein, the nth row of sub-pixels corresponds to displaying in black.

The data signal output unit 11 is switched from the OFF state to the ON state in the reserved period of the nth row of sub-pixels, that is, the data signal output unit 11 may start to work at a certain moment in the reserved period of the nth row of sub-pixels (that is, the data signal output unit 11 does not work before the moment and works after the moment), to output a stable first data signal before the data writing period of the nth row of sub-pixels, which ensures that the stable first data signal is supplied to the n+1th row of sub-pixels during the entire data writing period of the n+1th row of sub-pixels. The n+1th row of sub-pixels corresponds to displaying in white, that is, the first data signal is a data signal corresponding to the maximum display brightness (displaying a white screen) of the display panel 2. The stable first data signal means that the voltage of the first data signal is stable.

In this embodiment, the moment at which the data signal output unit 11 starts working is advanced, that is, the moment at which the data signal output unit 11 starts working is advanced from the moment at which the n+1th row of sub-pixels starts to scan to the reserved period of the nth row of sub-pixels, so as to reserve sufficient time for the data signal output by the data signal output unit 11 to be restored from an abnormal state to a normal state, thereby ensuring that a stable first data signal is written for the n+1th row of sub-pixels during the entire data writing period, which avoids display abnormality.

In some embodiments, the reserved period of each row of sub-pixels includes a light-emitting period immediately after the data writing period and an idle period immediately after the light-emitting period. The light-emitting period of a row of sub-pixels may be a period of time in which the pixel circuit in the row of sub-pixels drives the light emitting unit to emit light according to the written data signal. The idle period of a row of sub-pixels may be a redundant period between the row of sub-pixels and the next row of sub-pixels.

The data signal output unit is further configured to be in the OFF state during the light-emitting period of the nth row of sub-pixels, and to be switched from the OFF state to the ON state during the idle period of the nth row of sub-pixels, so as to supply the stable first data signal to the n+1th row of sub-pixels during the data writing period of the n+1th row of sub-pixels.

In the light-emitting period of the nth row of sub-pixels, the data signal output unit 11 is still in the OFF state, that is, the data signal output unit 11 is still not working, so as to avoid interference with the work of the pixel circuit. The data signal output unit 11 is switched from the OFF state to the ON state in the idle period of the nth row of sub-pixels, that is, the data signal output unit 11 may start to work at a certain moment in the idle period of the nth row of sub-pixels, to output a stable first data signal before the data writing period of the nth row of sub-pixels, which ensures that the stable first data signal is supplied to the n+1th row of sub-pixels during the entire data writing period of the n+1th row of sub-pixels.

In some embodiments, the scanning stage of each row of sub-pixels further includes a preparation period immediately before the data writing period. The preparation period of a row of sub-pixels may be a preparation time period for other signals needed for writing a data signal into the row of sub-pixels.

The data signal output unit 11 is further configured to be switched from the OFF state to the ON state within a reserved period of the nth row of sub-pixels to output a stable first data signal during a preparation period of the n+1th row of sub-pixels, and to supply the stable first data signal to the n+1th row of sub-pixels during a data writing period of the n+1th row of sub-pixels.

In the reserved period of the nth row of sub-pixels, for example, in the idle period of the nth row of sub-pixels, the data signal output unit 11 is switched from the OFF state to the ON state, so that the stable first data signal can be output in the preparation period of the n+1th row of sub-pixels, thus effectively ensuring that the data signal output unit 11 supplies the stable first data signal to the n+1th row of sub-pixels during the data writing period of the nth row of sub-pixels.

In some embodiments, as shown in FIG. 1, the drive module 1 may further include an enabling signal unit 12, and the enabling signal unit 12 is connected to the data signal output unit 11.

The enabling signal unit 12 is configured to supply a first potential enabling signal to the data signal output unit 11 during the data writing period of the nth row of sub-pixels; and supply a second potential enabling signal to the data signal output unit 11 within the reserved period of the nth row of sub-pixels. The data signal output unit 11 is further configured to be in the OFF state during a data writing period of the nth row of sub-pixels based on the control of the first potential enabling signal; to be switched from the OFF state to the ON state during the reserved period of the nth row of sub-pixels based on the control of the second potential enabling signal, so as to supply a stable first data signal to the n+1th row of sub-pixels during the data writing period of the n+1th row of sub-pixels.

The enabling signal output by the enabling signal unit 12 may control the data signal output unit 11 to be switched on or off. The potential of the first potential enabling signal is opposite to the potential of the second potential enabling signal. If the data signal output unit 11 is High Level On, that is, the data signal output unit 11 is turned on with high level input, the first potential enabling signal supplied by the enabling signal unit 12 to the data signal output unit 11 is at a low potential, and the second potential enabling signal is at a high potential. If the data signal output unit 11 is Low Level On, that is, the data signal output unit 11 is turned on with low level input, the first potential enabling signal supplied by the enabling signal unit 12 to the data signal output unit 11 is at a high potential and the second potential enabling signal is at a low potential.

During the data writing period of the nth row of sub-pixels, the enabling signal unit 12 inputs a first potential enabling signal to the data signal output unit 11 to control the data signal output unit 11 to be in an OFF state. At a certain moment in the reserved period of the nth row of sub-pixels, such as at a certain moment in the idle period of the nth row of sub-pixels, the enabling signal supplied by the enabling signal unit 12 to the data signal output unit 11 is converted from the first potential enabling signal to the second potential enabling signal, so that the data signal output unit 11 is switched from the OFF state to the ON state within the reserved period of the nth row of sub-pixels, ensuring that the data signal output unit 11 supplies a stable first data signal to the nth row of sub-pixels during the data writing period of the nth row of sub-pixels.

In some embodiments, the moment at which the data signal output unit 11 is switched from the OFF state to the ON state within a reserved period of the nth row of sub-pixels is located between the last one-fifth period and the last one-tenth period of the reserved period. The data signal output unit 11 is switched from the OFF state to the ON state during this period, and can output a stable first data signal during the preparation period of the n+1th row of sub-pixels, effectively ensuring that the data signal output unit 11 supplies a stable first data signal to the n+1th row of sub-pixels during the data writing period of the n+1th row of sub-pixels.

In some embodiments, the display module further includes a voltage module 3 configured to supply a second data signal to the nth row of sub-pixels during the data writing period of the nth row of sub-pixels.

In order to save power consumption, the data signal output unit 11 does not work during the data writing period of the nth row of sub-pixels, and the second data signal is supplied to the nth row of sub-pixels by the voltage module 3. The nth row of sub-pixels corresponds to displaying in black, that is, the second data signal is a data signal corresponding to the minimum display brightness (displaying a black screen) of the display panel 2.

In some embodiments, the display module further includes a selection module 4, the selection module 4 is connected between the data signal output unit 11 and the pixel circuit, and the selection module 4 is also connected between the voltage module 3 and the pixel circuit. The selection module 4 may be a data selector (multiplexer) Mux.

The selection module 4 is configured to be in the OFF state during the reserved period of the nth row of sub-pixels and in the ON state during the data writing period of the nth row of sub-pixels, so that the data signal output unit 11 supplies the stable first data signal to the n+1th row of sub-pixels.

The selection module 4 is in the OFF state during the reserved period of each row of sub-pixels, and is in the ON state during the data writing period of each row of sub-pixels. In the data writing period of the nth row of sub-pixels, the selection module 4 is in the ON state, and the second data signal output by the voltage module 3 is supplied to the nth row of sub-pixels, that is, the second data signal is written to the pixel circuits of the nth row of sub-pixels. In the reserved period of the nth row of sub-pixels, the selection module 4 is in the OFF state, stopping supplying the second data signal output by the voltage module 3 to the nth row of sub-pixels, that is, the second data signal is no longer written to the pixel circuits of the nth row of sub-pixels. In addition, in the reserved period of the nth row of sub-pixels, the data signal output unit 11 is switched from the OFF state to the ON state, that is, the data signal output unit 11 starts to work, the voltage module 3 stops outputting the second data signal, the data signal output unit 11 may output the first data signal with abnormal voltage, and the selection module 4 is in the OFF state, so that the first data signal with abnormal voltage is not supplied to the nth row of sub-pixels.

The selection module 4 is in OFF state during the preparation period of each row of sub-pixels. In the preparation period of the n+1th row of sub-pixels, the selection module 4 is in the OFF state and stops supplying the data signal output by the data signal output unit 11 to the n+1th row of sub-pixels, so that the data signal output unit 11 can still output the first data signal with abnormal voltage during the preparation period of the n+1th row of sub-pixels, but the data signal output unit 11 needs to output a stable first data signal before the data writing period of the n+1th row of sub-pixels. During the data writing period of the n+1th row of sub-pixels, the selection module 4 is in the ON state, and supplies the stable first data signal output by the data signal output unit 11 to the n+1th row of sub-pixels, that is, the stable first data signal is written to the pixel circuits of the n+1th row of sub-pixels.

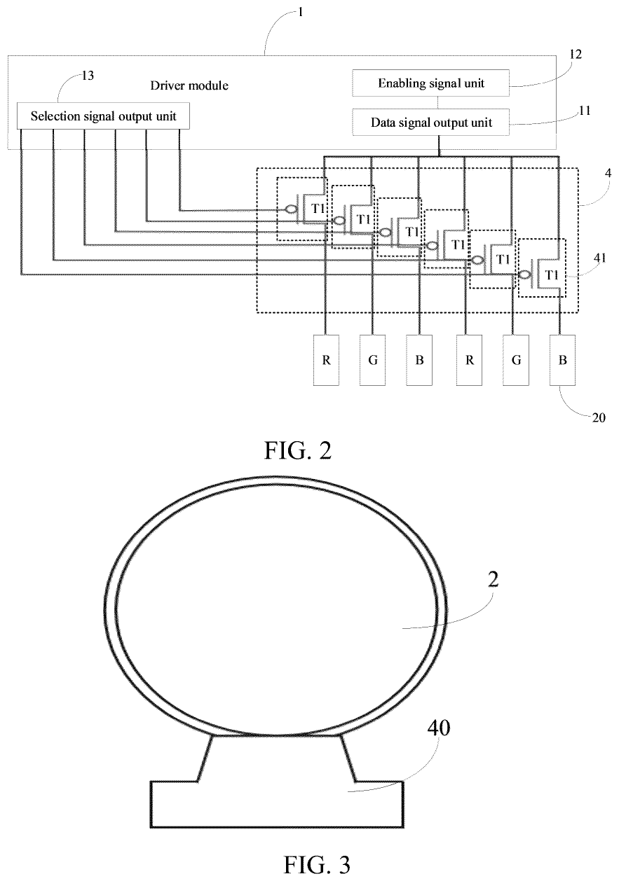

In some embodiments, as shown in FIG. 2, the selection module 4 includes a plurality of selection units 41, M columns of sub-pixels may be divided into a plurality of groups of sub-pixels, and each group of sub-pixels includes a plurality of columns of sub-pixels, and the plurality of selection units 41 are connected to pixel circuits of the plurality of columns of sub-pixels in each group of sub-pixels one by one. The data signal output unit 11 has a plurality of outputs, and each output of the data signal output unit 11 is connected to a plurality of selection units 41 in the selection module 4, so that each output of the data signal output unit 11 corresponds to a plurality of columns of sub-pixels in a group of sub-pixels. For example, the selection module 4 may adopt a Mux 1:6 solution, that is, the selection module 4 includes six selection units 41, every six columns of sub-pixels in M columns of sub-pixels is a group, and each output of the data signal output unit 11 corresponds to six columns of sub-pixels in a group of sub-pixels. In addition, the selection module 4 may adopt a Mux 1:9 solution, a Mux 1:12 solution, or other solutions, which are not specifically limited herein.

During the data writing period of each row of sub-pixels, the plurality of selection units 41 in the selection module 4 are turned on sequentially, to sequentially write data signals into pixel circuits of a plurality of columns of sub-pixels in a group of sub-pixels. All of the selection units 41 in the selection module 4 are in the OFF state during the preparation period and the reserved period of each row of sub-pixels. In this embodiment, the selection module 4 is provided, which can reduce the wiring space. As shown in FIG. 3, for the flexible AMOLED wearable product, the provision of the selection module 4 can save the space of the wiring area (Pad area) 40.

In some embodiments, the driver module 1 further includes a selection signal output unit 13, and the selection signal output unit 13 is connected to the selection module 4. The selection signal output unit 13 is configured to supply a first potential selection signal to the selection module 4 during a reserved period of the nth row of sub-pixels; and supply a second potential selection signal to the selection module 4 during a data writing period of the n+1th row of sub-pixels. The selection module 4 is configured to be in an OFF state during a reserved period of the nth row of sub-pixels based on the control of the first potential selection signal; and to be in an ON state during a data writing period of the nth row of sub-pixels based on the control of the second potential selection signal, so that the data signal output unit supplies the stable first data signal to the n+1th row of sub-pixels.

The selection signal output by the selection signal output unit 13 can control the ON or OFF of the selection module 4. The potential of the first potential selection signal is opposite to the potential of the second potential selection signal. If the selection module 4 is High Level On, that is, the selection module 4 is turned on with high level input, the first potential selection signal supplied by the selection signal output unit 13 to the selection module 4 is at low potential, and the second potential selection signal is at high potential; when the selection module 4 is Low Level On, that is, the selection module 4 is turned on with low level input, the first potential selection signal supplied by the selection signal output unit 13 to the selection module 4 is at high potential and the second potential selection signal is at low potential.

During the data writing period of the nth row of sub-pixels, the selection signal output unit 13 inputs a second potential selection signal to the selection module 4 to control the selection module 4 to be in an ON state, so that the voltage module 3 supplies the second data signal to the nth row of sub-pixels. In the reserved period of the nth row of sub-pixels, the selection signal output unit 13 inputs the first potential selection signal to the selection module 4 to control the selection module 4 to be in an OFF state and stop supplying the second data signal output by the voltage module 3 or the first data signal output by the data signal output unit 11 to the nth row of sub-pixels. During the preparation period of the n+1th row of sub-pixels, the selection signal output unit 13 inputs the first potential selection signal to the selection module 4 to control the selection module 4 to be in an OFF state and stop supplying the first data signal output by the data signal output unit 11 to the n+1th row of sub-pixels. During the data writing period of the n+1th row of sub-pixels, the selection signal output unit 13 inputs a second potential selection signal to the selection module 4 to control the selection module 4 to be in an ON state, so that the data signal output unit 11 supplies the stable first data signal to the n+1th row of sub-pixels.

In some embodiments, as shown in FIG. 2, each selection unit 41 includes a transistor T1, the control end of the transistor T1 is connected to the selection signal output unit 13, the input end of the transistor T1 is connected to the data signal output module 11 and the voltage module 3, and the output end of the transistor T1 is connected to the pixel circuit of the corresponding sub-pixel 20.

In some embodiments, the selection signal output unit 13 may include a high and low potential output sub-unit (not shown) and a digit sub-unit (not shown). The high and low potential output sub-unit is connected to the digit sub-unit, and the digit sub-unit is connected to the control ends of the transistors T1 in the plurality of selection units 41, respectively.

The high and low potential output sub-unit is used to supply a selection signal to the digit sub-unit. The digit sub-unit is used to convert the selection signal into a waveform with timing, so as to realize the ON or OFF of various selection units 41 in the selection module 4 at different moments.

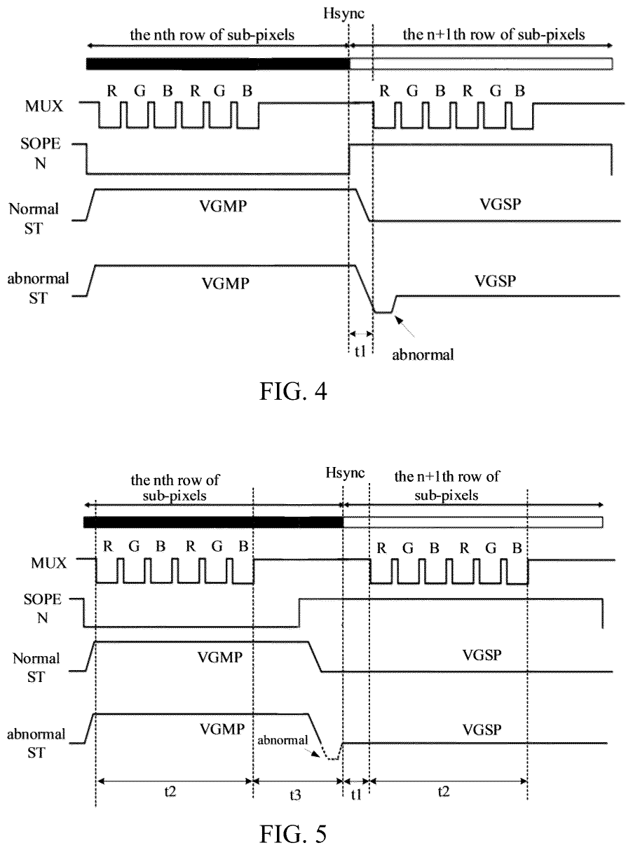

Hereinafter, the working principle of the display module provided according to an embodiment of the present application will be described in detail with reference to FIGS. 4 and 5.

The display module in this embodiment is a current-driven light-emitting device, and it will convert an external voltage into a current Id=A(VDD−Vdata)² for controlling the light-emitting device, where A is a constant, VDD is a power supply voltage, and Vdata is a data signal. VDD is a constant voltage, by changing the voltage of the data signal Vdata, the current flowing through the light-emitting device can be controlled, and thus the brightness of the light-emitting device is controlled. According to the current formula, the voltage of the data signal Vdata is the largest in the black screen (the lowest display brightness), and the current data signal Vdata is defined as VGMP; the voltage of the data signal Vdata is the smallest in the white screen (the highest display brightness), and the current data signal Vdata is defined as VGSP. The data signal Vdata varies between VGMP and VGSP as the pixel luminous intensity varies.

When the display panel 2 displays a screen, N rows of sub-pixels are scanned row by row line. The scanning of each row of sub-pixels is controlled by the row reference signal Hsync, that is, at the start moment of the scanning of each row of sub-pixels, a row reference signal Hsync is input to indicate that the row of sub-pixels has entered the scanning stage. When the nth row of sub-pixels corresponds to displaying in black, the enabling signal unit 12 supplies a first potential enabling signal (that is, an enabling signal SOPEN of a low potential) to the data signal output unit 11 to control the data signal output unit 11 to be in an OFF state, that is, to control the data signal output unit 11 not to output a data signal, so as to save power consumption. The voltage module 3 supplies the second data signal VGMP to the nth row of sub-pixels through the selection module 4, so that the input signal ST of the input of the selection module 4 (that is, the input of the transistor T1) is the second data signal VGMP.

When the n+1th row of sub-pixels corresponds to displaying in white, the data signal output unit 11 needs to work to supply the stable first data signal VGSP to the n+1th row of sub-pixels through the selection module 4. In related technologies, as shown in FIG. 4, the moment at which the enabling signal unit 12 supplies the second potential enabling signal (i.e., an enabling signal SOPEN of a high potential) to the data signal output unit 11 is the same as the moment at which the row reference signal Hsync of the n+1th row of sub-pixels starts, that is, at the start moment of the scanning stage of the n+1th row of sub-pixels, the enabling signal unit 12 supplies the second potential enabling signal (that is, an enabling signal SOPEN of a high potential) to the data signal output unit 11 to control the data signal output unit 11 to be switched from the OFF state to the ON state. Due to fluctuations in the production process of driver module 1, the voltage output capabilities of different data signal output units 11 are different. The data signal output unit 11 having normal voltage output capability can output a stable first data signal VGSP during the preparation period t1 of the n+1th row of sub-pixels, that is, for the input signal ST of the input of the selection module 4, voltage conversion (that is, converting from the second data signal VGMP to the stable first data signal VGSP) can be completed during the preparation period t1 of the n+1th row of sub-pixels, as the normal ST timing in FIG. 4. The data signal output unit 11 having weak voltage output capability cannot output the stable first data signal VGSP during the preparation period t1 of the n+1th row of sub-pixels, that is, for the input signal ST of the input of the selection module 4, voltage conversion cannot complete in the preparation period t1 of the n+1th row of sub-pixels, as a result, the input signal ST is still in an abnormal state during the data writing stage t2 of the n+1th row of sub-pixels (that is, the input signal ST is the first data signal with abnormal voltage), as the abnormal ST timing in FIG. 4. While during the data writing stage t2 of the n+1th row of sub-pixels, the selection signal output unit 13 supplies a plurality of second potential selection signals (i.e., a selection signal MUX of a low potential) to the selection module 4 to control the plurality of selection units 41 in the selection module 4 to be turned on sequentially, thus, the first data signal with abnormal voltage is supplied to the first sub-pixel (red sub-pixel R) in the n+1th row of sub-pixels, causing the appearance of a red line on the screen.

Based on this, as shown in FIG. 5, in an embodiment of the present application, the moment at which the enabling signal unit 12 supplies the second potential enabling signal (that is, an enabling signal SOPEN of a high potential) to the data signal output unit 11 is advanced to be within the reserved period t3 of the nth row of sub-pixels. During the data writing period t2 of the nth row of sub-pixels, the data signal output unit 11 is in the OFF state, and the selection signal output unit 13 supplies a plurality of second potential selection signals (i.e., a selection signal MUX of a low potential) to the selection module 4 to control the plurality of selection units 41 in the selection module 4 to be turned on sequentially, and write the second data signal VGMP of the voltage module 3 to the plurality of columns of sub-pixels sequentially. During the reserved period t3 of the nth row of sub-pixels, the selection signal output unit 13 supplies a first potential selection signal (i.e., a selection signal MUX of a high potential) to the selection module 4, to control the selection module 4 to be in the OFF state, and other signals start to work. The enabling signal unit 12 supplies a second potential enabling signal (that is, an enabling signal SOPEN of a high potential) to the data signal output unit 11 to control the data signal output unit 11 to be switched from the OFF state to the ON state. The data signal output unit 11 having normal voltage output capability can output a stable first data signal VGSP during the reserved period t3 of the nth row of sub-pixels, that is, for the input signal ST of the input of the selection module 4, voltage conversion (that is, converting from the second data signal VGMP to the stable first data signal VGSP) can be completed during the reserved period t3 of the n+1th row of sub-pixels, as the normal ST timing in FIG. 5. Since the time reserved for the data signal output unit 11 to output the stable first data signal becomes longer, the data signal output unit 11 having weak voltage output capability can output the stable first data signal VGSP even before the data writing period t2 of the n+1th row of sub-pixels, that is, for the input signal ST of the input of the selection module 4, voltage conversion (that is, converting from the second data signal VGMP to the stable first data signal VGSP) can be completed before the data writing period t2 of the n+1th row of sub-pixels, as the abnormal ST timing in FIG. 5. During the data writing period t2 of the n+1th row of sub-pixels, the selection signal output unit 13 supplies a plurality of second potential selection signals (i.e., a selection signal MUX of a low potential) to the selection module 4 to control a plurality of selection units 41 in the selection module 4 to be turned on sequentially, and a stable first data signal VGSP is written to a plurality of columns of sub-pixels sequentially, thereby avoiding writing a first data signal with abnormal voltage into a red sub-pixel R, to thoroughly solve the problem of a red line failure.

In the display module provided according to an embodiment of the present application, by controlling the data signal output unit to be in the OFF state during the data writing period of the nth row of sub-pixels, and controlling the data signal output unit to be switched from the OFF state to the ON state within the reserved period of the nth row of sub-pixels, the working time of the data signal output unit is advanced to reserve sufficient time for the data signal output unit to output the stable first data signal, thereby ensuring that the stable first data signal is written for the n+1th row of sub-pixels during the whole data writing period, avoiding display abnormality and improving the display effect.

Accordingly, an embodiment of the present application further provides a display device including the above-described display module.

In the display module provided according to an embodiment of the present application, by controlling the data signal output unit to be in the OFF state during the data writing period of the nth row of sub-pixels, and controlling the data signal output unit to be switched from the OFF state to the ON state within the reserved period of the nth row of sub-pixels, the working time of the data signal output unit is advanced to reserve sufficient time for the data signal output unit to output the stable first data signal, thereby ensuring that the stable first data signal is written for the n+1th row of sub-pixels during the whole data writing period, avoiding display abnormality and improving the display effect.

The display device according to an embodiment of the present application can be applied to any product or component with a display function, such as a mobile phone, a tablet computer, a television, a display, a laptop computer, a digital photo frame, or a navigator, etc.

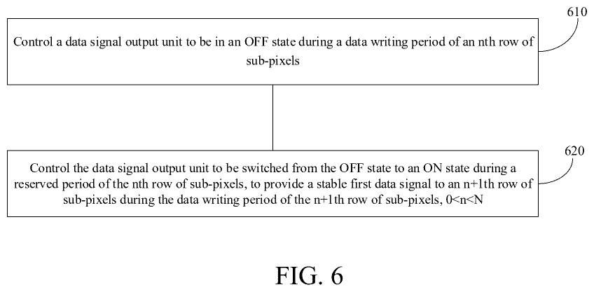

Accordingly, an embodiment of the present application further provides a control method for the display module, which can be applied to the above-described display module. FIG. 6 is a schematic flowchart of a control method for a display module according to an embodiment of the present application. The a display module includes a driver module and a display panel, the driver module includes a data signal output unit and the display panel includes N rows of sub-pixels, and a scanning stage of each row of sub-pixels includes a data writing period and a reserved period immediately after the data writing period.

As shown in FIG. 6, the control method for the display module provided according to an embodiment of the present application includes steps 610 to 620 as follows.

In Step 610, during a data writing period of an nth row of sub-pixels, a data signal output unit is controlled to be in an OFF state.

In Step 620, the data signal output unit is controlled to be switched from the OFF state to an ON state during a reserved period of the nth row of sub-pixels to provide a stable first data signal to an n+1th row of sub-pixels during the data writing period of the n+1th row of sub-pixels, 0<n<N.

In some embodiments, the reserved period includes a light-emitting period immediately after the data writing period and an idle period immediately after the light-emitting period. In step 620, controlling the data signal output unit to be switched from the OFF state to the ON state within the reserved period of the nth row of sub-pixels includes:

controlling the data signal output unit to be in the OFF state during the light-emitting period of the nth row of sub-pixels;

controlling the data signal output unit to be switched from the OFF state to the ON state during the idle period of the nth row of sub-pixels.

In some embodiments, a moment at which the data signal output unit is switched from the OFF state to the ON state within the reserved period of the nth row of sub-pixels is located between the last one-fifth period and the last one-tenth period of the reserved period.

In some embodiments, the first data signal is a data signal corresponding to the maximum display brightness of the display panel.

In the control method for the display module provided according to an embodiment of the present application, by controlling the data signal output unit to be in the OFF state during the data writing period of the nth row of sub-pixels, and controlling the data signal output unit to be switched from the OFF state to the ON state within the reserved period of the nth row of sub-pixels, the working time of the data signal output unit is advanced and sufficient time is reserved for the data signal output unit to output the stable first data signal, thereby ensuring that the stable first data signal is written for the n+1th row of sub-pixels in the whole data writing period, avoiding display abnormality and improving the display effect.

The terms “first”, “second” and the like in the specification and claims of the present application are used to distinguish similar objects, but are not used to describe a particular order or sequence. It should be understood that such used term may be interchangeable where appropriate so that embodiments of the present application can be implemented in an order other than those illustrated or described herein, and that objects distinguished by “first”, “second”, etc. are generally of the same class, and the number of objects is not limited, for example, the number of first objects may be “one” or “a plurality of”.

In the description of the present application, “a plurality of” means two or more.

In the description of the specification, descriptions of terms like “an embodiment”, “some embodiments”, “schematic embodiment”, “an example”, “a specific example” or “some examples” intend to indicate that specific features, structures, materials, or characteristics described in connection with an embodiment or example is contained in at least one embodiment or example of the present application. In this description, the exemplary description of the above terms is not necessarily directed to the same embodiment or example. Moreover, the specific features, structures, materials, or characteristics described may be combined in any one or more embodiments or examples in a proper way.

Although implementation modes of the present disclosure are disclosed above, contents described are only implementation modes used for ease of understanding of the present disclosure, but not intended to limit the present disclosure. Those skilled in the art may make any modification and change in the forms and details of the implementations without departing from the essence and scope of the present disclosure. However, the scope of protection of the present disclosure should still be subject to the scope defined by the attached claims.

1. A display module, comprising a driver module and a display panel, wherein the driver module comprises a data signal output unit, and the display panel comprises N rows of sub-pixels, and a scanning stage of each row of sub-pixels comprises a data writing period and a reserved period immediately after the data writing period,
the data signal output unit is configured to be in an OFF state during the data writing period of an nth row of sub-pixels and to be switched from the OFF state to an ON state during the reserved period of the nth row of sub-pixels, to provide a stable first data signal to an n+1th row of sub-pixels during the data writing period of the n+1th row of sub-pixels, 0<n<N.

2. The display module according to claim 1, wherein the reserved period comprises a light-emitting period immediately after the data writing period and an idle period immediately after the light-emitting period;
the data signal output unit is further configured to be in the OFF state during the light-emitting period of the nth row of sub-pixels and to be switched from the OFF state to the ON state during the idle period of the nth row of sub-pixels, to provide the stable first data signal to the n+1th row of sub-pixels during the data writing period of the n+1th row of sub-pixels.

3. The display module according to claim 1, wherein the scanning stage further comprises a preparation period immediately before the data writing period;
the data signal output unit is further configured to be switched from the OFF state to the ON state during the reserved period of the nth row of sub-pixels, to output the stable first data signal during the preparation period of the n+1th row of sub-pixels and to provide the stable first data signal to the n+1th row of sub-pixels during the data writing period of the n+1th row of sub-pixels.

4. The display module according to claim 1, wherein the driver module further comprises an enabling signal unit;
the enabling signal unit is configured to provide a first potential enabling signal to the data signal output unit during the data writing period of the nth row of sub-pixels; and provide a second potential enabling signal to the data signal output unit during the reserved period of the nth row of sub-pixels;
the data signal output unit is further configured to be in the OFF state during the data writing period of the nth row of sub-pixels based on control of the first potential enabling signal; to be switched from the OFF state to the ON state during the reserved period of the nth row of sub-pixels based on control of the second potential enabling signal, to provide the stable first data signal to the n+1th row of sub-pixels during the data writing period of the n+1th row of sub-pixels.

5. The display module according to claim 1, wherein a moment at which the data signal output unit is switched from the OFF state to the ON state during the reserved period of the nth row of sub-pixels is located between a last one-fifth period and a last one-tenth period of the reserved period.

6. The display module according to claim 1, wherein the first data signal is a data signal corresponding to a maximum display brightness of the display panel.

7. The display module according to claim 1, wherein the display module further comprises a voltage module;
the voltage module is configured to provide a second data signal to the nth row of sub-pixels during the data writing period of the nth row of sub-pixels.

8. The display module according to claim 7, wherein the second data signal is a data signal corresponding to a minimum display brightness of the display panel.

9. The display module according to claim 1, wherein the display module further comprises a selection module;
the selection module is configured to be in the OFF state during the reserved period of the nth row of sub-pixels and in the ON state during the data writing period of the nth row of sub-pixels, to enable the data signal output unit to provide the stable first data signal to the n+1th row of sub-pixels.

10. The display module according to claim 9, wherein the driver module further comprises a selection signal output unit;
the selection signal output unit is configured to provide a first potential selection signal to the selection module during the reserved period of the nth row of sub-pixels; and provide a second potential selection signal to the selection module during the data writing period of the n+1th row of sub-pixels;
the selection module is further configured to be in the OFF state during the reserved period of the nth row of sub-pixels based on control of the first potential selection signal; and in the ON state during the data writing period of the nth row of sub-pixels based on control of the second potential selection signal, to enable the data signal output unit to provide the stable first data signal to the n+1th row of sub-pixels.

11. A display device, comprising the display module according to claim 1.

12. A control method for a display module, the display module comprising a driving module and a display panel, wherein the driving module comprises a data signal output unit and the display panel comprises N rows of sub-pixels, and a scanning stage of each row of sub-pixels comprises a data writing period and a reserved period immediately after the data writing period; the method comprises:
controlling the data signal output unit to be in an OFF state during the data writing period of an nth row of sub-pixels; and
controlling the data signal output unit to be switched from the OFF state to an ON state during the reserved period of the nth row of sub-pixels, to provide a stable first data signal to an n+1th row of sub-pixels during the data writing period of the n+1th row of sub-pixels, 0<n<N.

13. The control method for the display module according to claim 12, wherein the reserved period comprises a light-emitting period immediately after the data writing period and an idle period immediately after the light-emitting period;
controlling the data signal output unit to be switched from the OFF state to the ON state during the reserved period of the nth row of sub-pixels, comprises:
controlling the data signal output unit to be in the OFF state during the light-emitting period of the nth row of sub-pixels; and
controlling the data signal output unit to be switched from the OFF state to the ON state during the idle period of the nth row of sub-pixels.

14. The control method for the display module according to claim 12, wherein a moment at which the data signal output unit is switched from the OFF state to the ON state during the reserved period of the nth row of sub-pixels is located between a last one-fifth period and a last one-tenth period of the reserved period.

15. The control method for the display module according to claim 12, wherein the first data signal is a data signal corresponding to a maximum display brightness of the display panel.
